(19) United States
(12) Patent Application Publication
(10) Pub. No.: US 2020/0223411 A1
(43) Pub. Date: Jul. 16, 2020

(54) TRACTOR POWERED PRESSURIZED SEMI-TRACTOR AND TRAILER WASHER

(71) Applicant: Mark RICHTER, EDWARDSPORT, IN (US)

(72) Inventor: Mark RICHTER, EDWARDSPORT, IN (US)

(21) Appl. No.: 16/744,535

(22) Filed: Jan. 16, 2020

Related U.S. Application Data
(60) Provisional application No. 62/793,114, filed on Jan. 16, 2019.

(51) Int. Cl. B60T 8/48; B60S 1/66; B08B 3/02

(52) U.S. Cl. CPC B60T 8/48; B08B 3/028; B60S 1/66

(57) ABSTRACT

An on-board pressurized washing system that utilizes a semi-tractor or trailer's compressed air brake line as its source of compressed air. When the tractor is parked, the air brake lines may be disconnected from the trailer and hooked up to the pressurized washing system. The system is fully mobile and does not need an external power source or water line during operation. The water from the water tank and the compressed air are sprayed separately or together from a spray wand to meet cleaning and sanitation needs of truck drivers in any location when they may not have access to electricity or a water source.

### CROSS REFERENCE TO RELATED APPLICATIONS

This application claims the benefit of US Provisional Application No. 62/793,114 filed Jan. 16, 2019.

### FIELD OF THE INVENTION

The present invention relates to pressurized washer systems for semi-tractors and trailers.

### BACKGROUND

Being able to wash and/or sanitize a semi-tractor or trailer may cause many challenges. These include a driver having to locate and drive to a washing facility, wait in line, and then pay to have their trailer washed out. Further, sanitization is not typically included in these washing facilities and the driver has little control over the wash quality.

Considering the ever increasing requirements and regulations for food safety, the ability for a driver or person washing a container transporting perishable commodities to have complete control of washing and sanitizing procedures is an advantage. Without a system such as this a transportation company is at the mercy of the procedures of washing facilities near their truck's locations.

Other types of washing machines have been introduced to wash the interior and exterior surfaces of semi-tractors and trailers. These other washing machines, however, need to be connected to some sort of external power source, such as an electrical outlet. It is also necessary for these types of machines to be simultaneously hooked up to a consistent outside source of water. These restrictions severely limit the location and timing of how and when a person may wash a tractor or trailer.

Therefore, the primary objective of this invention is to be able to power wash a tractor or trailer without needing an external power or water source, so drivers or those wishing to wash a tractor or trailer will not be limited by time or location. Utilizing the compressed air from a tractor's compressed air source, such as its air brake system, allows the invention to be utilized whenever the vehicle is in the parked position. Further, this invention allows a person to decide the amount of soap or sanitizer to be used in the water tank.

### SUMMARY OF THE INVENTION

One object of the present invention to provide a pressurized washing machine that is capable of being used in any location without needing to be hooked up to any outside source of electrical power or water during use. By utilizing the tractor's own compressed air brake line to pressurize the water in a tank and to provide pressure to a spray wand, the invention allows for a self-contained power washing system. The separate air and water valves located at the spray wand also allow for complete airflow, complete water flow, or a mixture, allowing for complete cleaning, sanitizing, and drying while minimizing run-off water. This invention allows a semi-tractor and/or trailer to be washed or washed out and sanitized at any location and allows the person washing to have complete control of washing and sanitizing procedures, also giving them the authority to complete any documents required by regulating agencies.

The water tank is filled when the washing system is not in use. Depending on the size of the tank, a given amount of water is used with no water added during operation. Therefore, an exact and optimum concentration of cleaning, sanitizing, and anti-freeze solution can be obtained. All of these can be environmentally friendly and added to the tank using a garden hose connection located on an outlet water line.

A trucking company with numerous trucks and trailers that use one washing facility for all of their equipment should find that utilizing the on-board washer results in tremendous savings, the greatest of which is eliminated down time. Utilizing an existing air source is also extremely important as any added weight on a truck can take away from the amount of paying cargo a truck can hold. A trucking company whose equipment is outfitted with the on-board washer will be attractive, especially to customers concerned with food safety. Additionally, a pressurized thirty-gallon container of water mounted on a tractor/trailer with an application hose capable of a 60′ reach may also be useful in the event of incidents involving fire or caustic materials.

### BRIEF DESCRIPTION OF THE DRAWINGS

FIG. 1 shows a side view of a tractor connected to a trailer with one embodiment of the present invention.

FIG. 2 shows a side view of a tractor with a suggested location for the tank to be mounted to the tractor.

FIG. 3 shows a side view of a trailer with its air brake lines and a suggested location for the tank to be mounted to the trailer.

FIG. 4 shows the water tank mounted on a hand truck via a strap with various components of the present invention.

### DETAILED DESCRIPTION

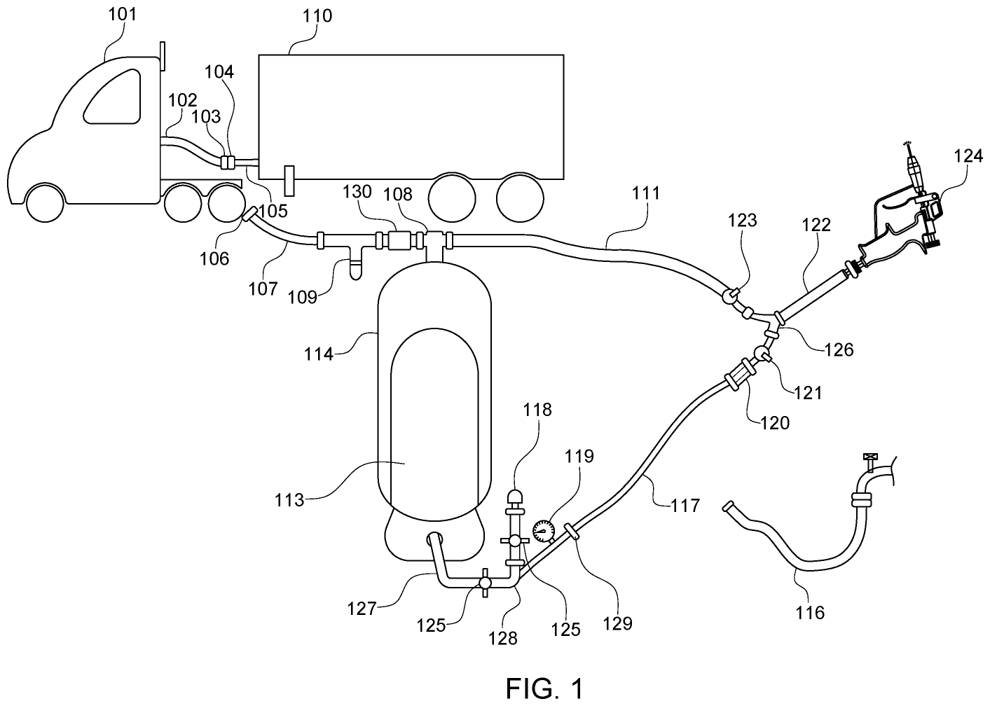

The present invention provides a pressurized washing system that utilizes pressurized air from a tractor's 101 compressed air source, such as an air brake system, as shown in one embodiment in FIG. 1. A trailer 110 as shown is the size of the commonly known semi-trailer but is not limited to any particular size of trailer so long as the tractor 101 has a compressed air source, such as a compression air brake system. The tractor 101 and trailer's 110 existing compression air brake system is not spliced into or tampered with in any way.

To utilize the embodiment of the present invention depicted in FIG. 1, a person should start by connecting a water source, such as a garden hose 116, to a water inlet connector 129. A first and a second shut-off valve 125 should both be positioned to allow water to flow through the system while filling a bladder 113 within a tank 114. Once both the first and second shut-off valves 125 are in their open-position, the water source can be used to fill the bladder 113. The second shut-off valve 125 is connected to a pressure relief valve 118 that will remain closed as the bladder 113 is being filled and will open if the water pressure becomes too great. A nearby pressure gauge 119 is used to assist in determining when the amount of water in the tank 114 is sufficient. After the bladder 113 contains sufficient water, both the first and second shut-off valves 125 should be positioned to disallow water from flowing. The water source can then be disconnected and the pressure washing system can be moved to a remote location that does not contain either electricity or water.

When the tractor 101 and trailer 110 are parked and the brakes are set, a first air line 102 and a second air line 105 are disconnected from the trailer brake system using a first gladhand 103 and a second gladhand 104. The first air line 102 is connected to the first gladhand 103 that can then be connected to a third gladhand 106. An auxiliary air line also connecting the tractor 101 and trailer 110, not shown in FIG. 1, is also disconnected with the air outlet form the tractor 101 being capped so no leaking occurs.

The third gladhand 106 is connected to an air tank inlet hose 107 that is further connected to an air manifold 108. The air manifold 108 is further connected to an outlet air hose 111 and the tank 114. The outlet air hose 111 is then connected to a first adjustment valve 123, which allows or disallows air flow to a triggered spray gun manifold 126 and ultimately a triggered spray gun 124.

A water outlet hose 117 can then be attached to the water inlet connector 129. Once the water outlet hose 117 is connected, the first shut-off valve 125 can be moved to the open-position allowing water to move from the bladder 113 and into a water line 127.

After the first gladhand 103 and third gladhand 106 have been connected and the water outlet hose 117 is attached to the water inlet connector 129, the compressed air source of the tractor is activated, which provides compressed air to both the tank 114 and ultimately the triggered spray gun 124. Once the compressed air is in the tank 114, it forces the water out of the bladder 113, through the water line 127, a water manifold 128, the pressure gauge 119, the water outlet hose 117, a ball cone check valve 120, and to a second adjustment valve 121. The first and second adjustment valves 123, 121 can be adjusted to distribute air, water, or a desired mixture through a triggered spray gun manifold 126, through a mixed air and water hose 122, and from the triggered spray gun 124. The spray from the triggered spray gun 124 may be directed at a tractor, a trailer, or any other object or vehicle the user desires to clean.

The adjustment valves 121, 123 are used to turn the air and water on and off separately as well as adjust a mixture of both. Should air and water be allowed to mix in the pressurized spray washing system, water could dissipate and spread backwards in the air lines 102, 107, 111. If the water reaches the air compressor of the tractor 101, it may result in compressor failure. A sight glass 109 may be placed intermediate the air tank inlet hose 107 and the air manifold 108 if desired to monitor the system for leaks of water from either the tank 114 or from the triggered spray gun 124. A spring loaded check valve 130 placed intermediate the sight glass 109 and the air manifold 108 provides protection against the back-flow of water from either the tank 114 or the triggered spray gun 124. The ball cone check valve 120 provides additional protection against back-flow of water from the application gun.

The air tank inlet hose 107 is continuously connected to the tank 114 and the air supply from the tractor 102 while the system is in use. Air pressure is controlled and maintained between 90 and 140 p.s.i. by the tractor's compressor and regulator and will remain constant in the spray washing system until the bladder 113 is empty.

While the water can flow in and out of the bladder 113, the tank is not connected to an inlet water line during operation. A standard garden hose 116 is depicted as the inlet water line in FIG. 1, but any method of providing water to the bladder 113 utilizing an amount of water pressure to allow filling the bladder 113 from the bottom will suffice. The addition of a concentrated cleaner, sanitizer, and/or anti-freeze solution may also be added to the bladder 113. This allows for a known and optimal concentration to be reached for use in cleaning the vehicle.

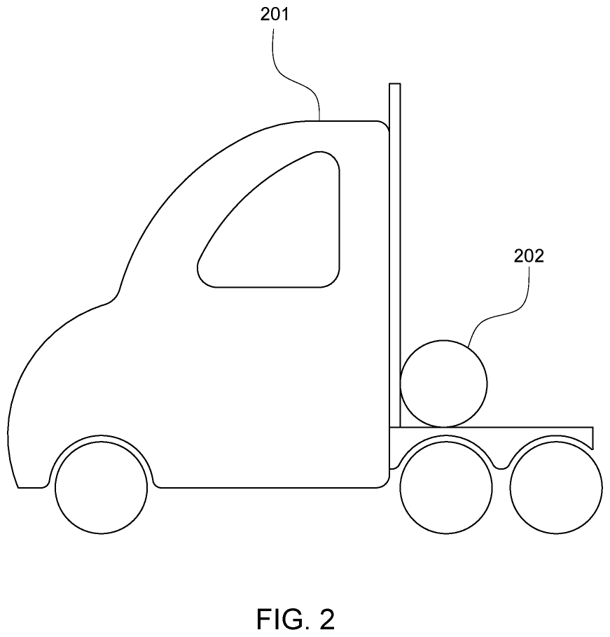

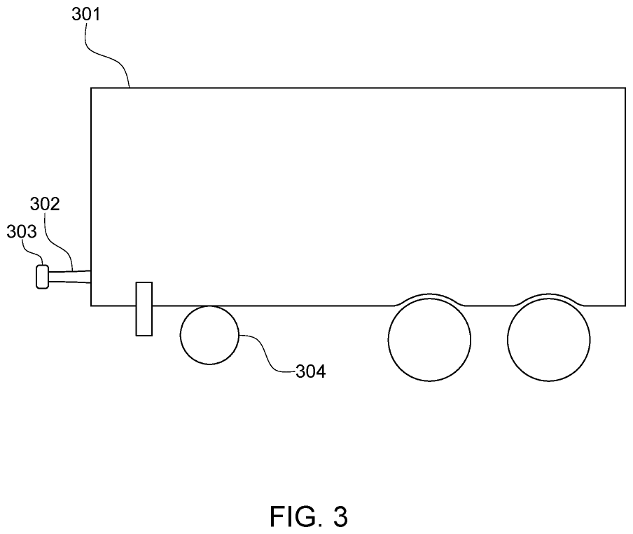

FIG. 2 shows one embodiment in which the tank 114 is mounted to the tractor 101. FIG. 3 shows another embodiment in which the tank 114 is mounted to the trailer 110. FIG. 3 further shows the air line 105 and gladhand 104 that are disconnected from a tractor and not used in the spray washing process. While each of these show the tank 114 mounted in a suggested place, any location that does not inhibit the proper working of the tractor or trailer, or violate any regulations will suffice. Further, the spray washing plumbing can either be installed by drilling holes into the trailer or long lengths of hoses can be used to reach the inside of the trailer through the rear doors. If the plumbing is to be installed by drilling holes through the trailer, the air outlet hose 111 and the water outlet hose 117 can connect to the tank 114 that is mounted outside of the trailer 110 by fittings located both inside and outside of the trailer 110 allowing for either interior or exterior cleaning.

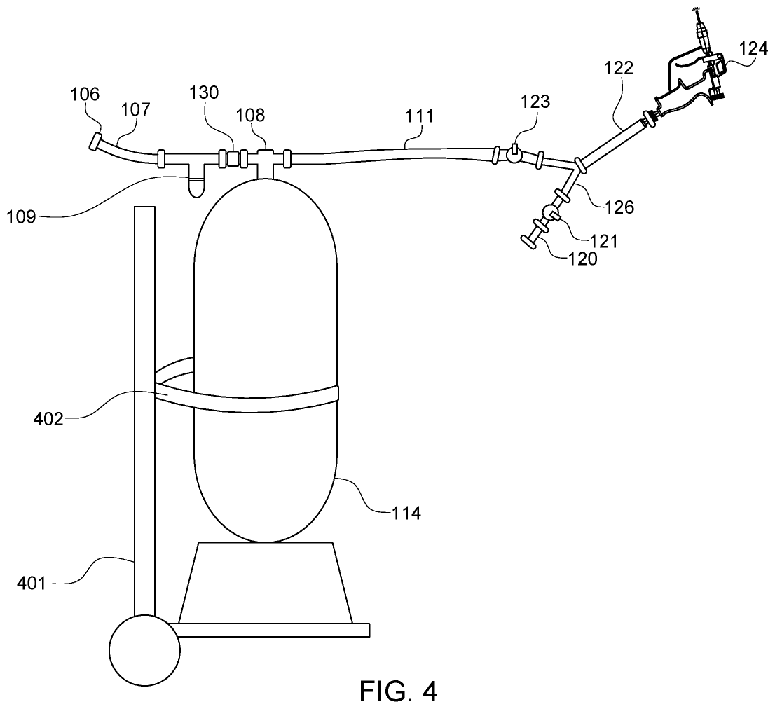

FIG. 4 shows another alternative embodiment in which the tank 114 is mounted to a hand truck 401 and may be secured to the hand truck with a strap 402. This configuration may be mounted to either the trailer or tractor, with the back of the tractor's cab being the ideal location for mounting. The mobility of this embodiment makes it more versatile and easily moved to a more convenient washing location. It can even be completely disconnected from the tractor or trailer and manually wheeled to be re-filled at a nearby water source. While FIG. 4 does not show all of the elements shown in FIG. 1, it is to be understood that all of the elements in FIG. 1 that are necessary for the spray washing system to work are also utilized when the spray washing system is in use in FIG. 4.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1. A method of cleaning a vehicle, comprising:
providing a tractor comprising:
a compressed air source connectible to an air brake system;
a first gladhand in communication with the compressed air source;
providing a trailer comprising:
an air hose for a brake system of the trailer in communication with a second gladhand;
providing a spray washing system comprising:
a third gladhand in communication with a water tank and a spray gun;
the water tank comprising:
an air inlet;
an internal bladder in communication with a water inlet and a water outlet, the water outlet being in communication with the spray gun;
a first adjustable valve intermediate the third gladhand and the spray gun for controlling a flow of compressed air to the spray gun;
a second adjustable valve intermediate the water tank outlet for controlling a flow of water to the spray gun;
providing water to the bladder of the water tank;
connecting the first gladhand of the tractor to the third gladhand of the spray washing system;
activating the compressed air source of the tractor to thereby provide compressed air to the water tank and to force water in the water tank to the spray gun; and
adjusting the first and second adjustable valves to allow an air-water mixture to be sprayed from the spray gun.

2. The method of cleaning a vehicle of claim 1 wherein:
prior to connecting the first gladhand to the third gladhand, the first gladhand is connected to the second gladhand of the trailer;
disconnecting the first gladhand of the tractor from the second gladhand of the trailer; and
wherein spray from the spray gun is directed toward the trailer.

3. The method of cleaning a vehicle of claim 1, wherein:
the spray washing system further comprises a pressure relief valve intermediate the water tank and the spray gun.

4. The method of cleaning a vehicle of claim 1, wherein:
the spray washing system further comprises a sight glass intermediate the third gladhand and the water tank.

5. A tractor with an attached spray washing system comprising:
a tractor comprising:
a compressed air source connectible to an air brake system;
a first gladhand in communication with the compressed air source;
a spray washing system comprising:
a second gladhand in communication with a water tank and a spray gun;
the water tank connectible to the tractor comprising:
an air inlet;
an internal bladder in communication with a water inlet and a water outlet, the water outlet being in communication with the spray gun;
a first adjustable valve intermediate the second gladhand and the spray gun for controlling a flow of compressed air to the spray gun; and
a second adjustable valve intermediate the water tank outlet and the spray gun for controlling a flow of water to the spray gun.

6. The tractor with an attached spray washing system of claim 5 wherein
the spray washing system further comprises a sight glass and a spring loaded check valve intermediate the second gladhand and the water tank.

7. The tractor with an attached spray washing system of claim 5 wherein:
the spray washing system further comprises a pressure relief valve intermediate the water tank outlet and the spray gun.

8. The tractor with an attached spray washing system of claim 5 wherein:
the spray washing system further comprises a ball cone check valve intermediate the water tank outlet and the spray gun.

9. The tractor with an attached spray washing system of claim 5 wherein:
the spray washing system further comprises a shut off valve intermediate the water tank outlet and the spray gun.

10. A trailer with an attached spray washing system comprising:
a trailer;
a spray washing system mounted on the trailer comprising:
a gladhand connectible to a pressurized air source, in communication with a water tank and a spray gun;
the water tank comprising:
an air inlet;
an internal bladder in communication with a water inlet and a water outlet, the water outlet being in communication with the spray gun;
a first adjustable valve intermediate the gladhand and the spray gun for controlling a flow of compressed air to the spray gun; and
a second adjustable valve intermediate the water tank outlet and the spray gun for controlling a flow of water to the spray gun.

11. The trailer with an attached spray washing system of claim 10 wherein
the spray washing system further comprises a sight glass and a spring loaded check valve intermediate the gladhand and the water tank.

12. The trailer with an attached spray washing system of claim 10 wherein:
the spray washing system further comprises a pressure relief valve intermediate the water tank outlet and the spray gun.

13. The trailer with an attached spray washing system of claim 10 wherein:
the spray washing system further comprises a ball cone valve intermediate the water tank outlet and the spray gun.

14. The tractor with an attached spray washing system of claim 10 wherein:
the spray washing system further comprises a shut off valve intermediate the water tank outlet and the spray gun.

15. A hand truck with an attached spray washing system comprising:
a hand truck comprising:
a long handle;
a set of two wheels;
a platform intermediate the long handle and the set of two wheels;
a spray washing system mounted on a hand truck comprising:
a gladhand connectible to an air brake system of a tractor wherein:
the gladhand is in communication with a water tank and a spray gun;
the water tank connectible to the hand truck comprising:
an air inlet;
an internal bladder in communication with a water inlet and a water outlet, the water outlet being in communication with the spray gun;
a first adjustable valve intermediate the gladhand and the spray gun for controlling a flow of compressed air to the spray gun; and
a second adjustable valve intermediate the water tank outlet and the spray gun for controlling a flow of water to the spray gun.

16. The hand truck with an attached spray washing system of claim 15 wherein
the spray washing system further comprises a sight glass and a spring loaded check valve intermediate the gladhand and the water tank.

17. The hand truck with an attached spray washing system of claim 15 wherein:
the spray washing system further comprises a pressure relief valve intermediate the water tank outlet and the spray gun.

18. The hand truck with an attached spray washing system of claim 15 wherein:
the spray washing system further comprises a ball cone valve intermediate the water tank outlet and the spray gun.

19. The tractor with an attached spray washing system of claim 15 wherein:
the spray washing system further comprises a shut off valve intermediate the water tank outlet and the spray gun.
